(19) United States
(12) Patent Application Publication
(10) Pub. No.: US 2008/0029037 A1
(43) Pub. Date: Feb. 7, 2008

(54) Anti ant pet food bowl

(76) Inventor: Kenneth Kenji Ogata, Claremont, CA (US)

Correspondence Address: Kenneth Ogata, 95 - 982 WIKAO ST L - 201, MILILANI, HI, 96789, US

(21) Appl. No.: 11/497,481

(22) Filed: Aug. 2, 2006

(51) Int. Cl. A01K 5/01

(52) U.S. Cl. 119/61.53

(57) ABSTRACT

The Anti Ant Pet Food Bowl is unique because it has a water trough encircling the bottom of the bowl. Placing water in the trough prevents ants and any insects and bugs from reaching the food in the bowl.

### BRIEF SUMMARY OF THE INVENTION

Ants and insects crawling unto the food in your pet food bowl has always been a major problem. The Anti Ant Bowl, which combines a pet food bowl with a water trough encircling the bowl at the bottom, molded as one unit, will prevent any crawling insects from reaching the cat or dog food in the bowl.

### DESCRIPTION OF THE PREFERRED EMBODIMENT

The ¾ view of the Anti Ant Pet Food Bowl with two versions are described below with drawing on separate page, are as follows:

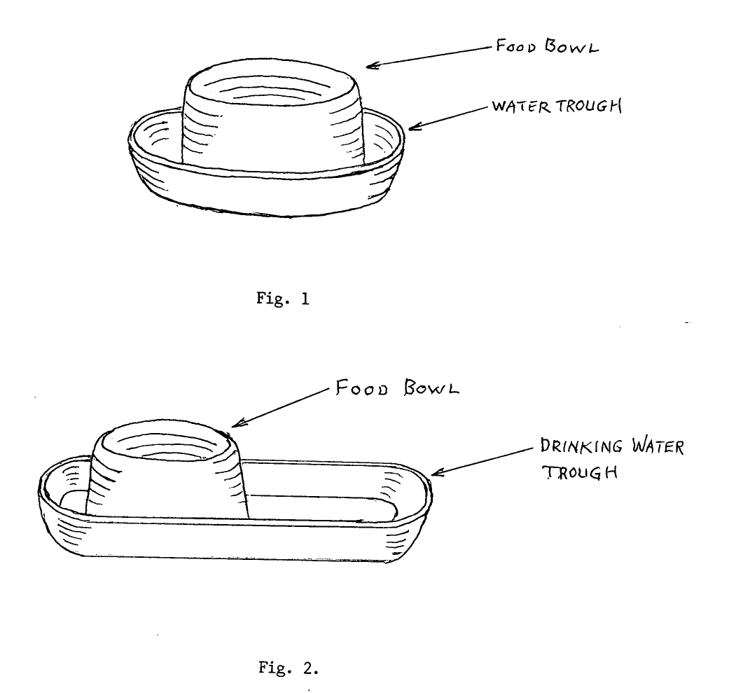

FIG. 1—Food bowl with water trough encircling the bottom of bowl.

FIG. 2—Same food bowl with an extended water trough at the bottom of bowl.

### DETAILED DESCRIPTION OF THE INVENTION

The pet food bowl has a water trough molded as one unit at the bottom of the bowl. Since the water trough encircles the bottom of the bowl, placing food in the bowl and filling the trough with water will prevent any insects from reaching the food bowl. This pet food bowl has another version with an extended water trough. The extended water trough will not only be a barrier to insects reaching the food but will also provide drinking water for your cat or dog. Hence a separate food bowl and a drinking bowl will not be required. See FIG. 2 of drawing. The molded pet food bowl could be made of plastic, stainless steel or aluminum.

1. What I claim as my invention is a pet food bowl with a water trough encircling and molded to the bottom of the bowl to prevent ants and other insects from reaching the food bowl.
